(19) United States
(12) Patent Application Publication
(10) Pub. No.: US 2026/0322321 A1
(43) Pub. Date: Oct. 15, 2026

(54) VARIABLE TERRAIN SOLAR TRACKER

(71) Applicant: Nevados Engineering, Inc., Oakland, CA (US)

(72) Inventors: Yezin Taha, San Francisco, CA (US); Amitoj Gill, Roseville, CA (US); Laura Sverchek, San Francisco, CA (US); Jos Cocquyt, Berkeley, CA (US); Sam Prest, Fairfield, CT (US); Jenya Meydbray, Mill Valley, CA (US); Matthew Cieplack, San Francisco, CA (US); Ben Blasdell, Berkeley, CA (US)

(73) Assignee: Nevados Engineering, Inc., Oakland, CA (US)

(21) Appl. No.: 19/699,811

(22) Filed: Jun. 5, 2026

Related U.S. Application Data
(63) Continuation of application No. PCT/US2024/058853, filed on Dec. 6, 2024.
(60) Provisional application No. 63/608,078, filed on Dec. 8, 2023.

(51) Int. Cl. H02S 20/32; G01J 1/42; G01S 3/786; G01W 1/00; G05D 3/10; H02S 50/00

(52) U.S. Cl. CPC H02S 20/32; G01J 1/4204; G01J 1/4228; G01S 3/7861; G01W 1/00; G05D 3/105; H02S 50/00; G01J 2001/4266

(57) ABSTRACT

Solar trackers and control systems prevent damage from weather events—such as hail—by orienting solar panels at optimal angles during such weather events. These angles may be achieved and managed by the physical stops of the slew drives and mechanical stop assemblies in the tracker. Control systems may trigger stowing of the solar panels during such weather events in a variety of ways, including comparing irradiance measured from the solar panels with expected irradiance.

### CROSS REFERENCE TO RELATED APPLICATIONS

The application is a continuation of PCT Application PCT/US2024/058853 titled “METHOD OF STOWING OF SOLAR PANEL” filed Dec. 6, 2024, which claims priority to U.S. Provisional Patent Application 63/608,078 titled “VARIABLE TERRAIN SOLAR TRACKER” filed Dec. 8, 2023. Both of the above applications are incorporated herein by reference in its entirety.

### FIELD OF THE INVENTION

The invention relates generally to solar trackers, particularly solar trackers and control systems for solar trackers that mitigate damage against weather events (e.g., hail).

### BACKGROUND

Two types of mounting systems are widely used for mounting solar panels. Fixed tilt mounting structures support solar panels in a fixed position. The efficiency with which panels supported in this manner generate electricity can vary significantly during the course of a day, as the sun moves across the sky and illuminates the fixed panels more or less effectively. However, fixed tilt solar panel mounting structures may be mechanically simple and inexpensive, and in ground-mounted installations may be arranged relatively easily on sloped and/or uneven terrain.

Single axis tracker solar panel mounting structures allow rotation of the panels about an axis to track the motion of the sun across the sky. For example, a single axis tracker may be arranged with its rotation axis oriented generally North-South, so that rotation of the panels around the axis can track the East-West component of the sun's daily motion. Alternatively, a single axis tracker may be arranged with its rotation axis oriented generally East-West, so that rotation of the panels around the axis can track the North-South component of the sun's daily (and seasonal) motion. Solar panels supported by single axis trackers can generate significantly more power than comparable panels arranged in a fixed position.

Solar trackers are often at the risk of weather events. These weather events, such as high winds and hail, can result not only in power generation inefficiencies within the solar trackers, but can in extreme circumstances also result in damage to the solar trackers themselves. Particularly, hail can result in damage to the solar panels on the trackers, especially when the hail strikes the solar panel surface with a direct hit (i.e., with a small angle of incidence). Rotating the solar panels to turn direct hits into grazing or glancing hits helps prevent or mitigate damage to the solar panels. However, trackers often innately prevent rotation of the solar panels past a certain point. This is because steeper solar panels put heavier wind loads on the tracker, which may cause uprooting of the foundations or other structural damage.

Consequently, there is a need for an improved tracker and/or control system that can properly prevent damage from weather events.

### SUMMARY

Solar trackers and control systems presented in this disclosure advantageously prevent and/or mitigate damage from weather events. They allow solar panels to be oriented at steeper angles than conventionally used, lowering the chance that they suffer damage from, e.g., hail. Improved control systems take advantage of this steep angle and further ensure that costly damage to the solar panels is prevented.

These and other embodiments, features and advantages of the present invention will become more apparent to those skilled in the art when taken with reference to the following more detailed description of the invention in conjunction with the accompanying drawings that are first briefly described.

### BRIEF DESCRIPTION OF THE DRAWINGS

FIG. 1 shows a perspective view of a solar site array with three neighboring trackers and three bays of solar modules each.

FIG. 2 shows a cross section of a single tracker with three bays of solar modules on an upward slope extending along the North-South axis.

FIG. 3 shows a cross section of a solar site array with three trackers neighboring each other along the East-West axis.

FIG. 4 shows a perspective view of an all-terrain solar tracker with different bearings in between the bays of solar modules.

FIG. 5 shows a block diagram of a computer system in communication with a solar panel array.

FIG. 6 shows a block diagram of a solar panel control system in communication with a solar panel array.

FIG. 7 shows an example slew drive for a solar tracker.

FIG. 8 shows a side view of a tracker with slew drives having cradles positioned at different locations with respect to the axes of the solar support modules.

FIG. 9 shows a flow diagram illustrating a stowing process for the solar panels based on irradiance.

FIG. 10 shows a flow diagram illustrating a stowing process for the solar panels based on an on-site hail sensor.

FIG. 11 shows a flow diagram illustrating a stowing process for the solar panels based on off-site information.

FIGS. 12a-12f shows cross sections of a single tracker with a solar panel oriented at different angles.

FIG. 13 shows an example mechanical stop assembly installed in a tracker with bars on both sides of a bearing.

FIG. 14 shows an example mechanical stop assembly with a bar on one side of a bearing.

### DETAILED DESCRIPTION

The following detailed description should be read with reference to the drawings, in which identical reference numbers refer to like elements throughout the different figures. The drawings, which are not necessarily to scale, depict selective embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention.

As used in this specification and the appended claims, the singular forms “a,” “an,” and “the” include plural referents unless the context clearly indicates otherwise. Also, the term “parallel” is intended to mean “substantially parallel” and to encompass minor deviations from parallel geometries. The term “vertical” refers to a direction parallel to the force of the earth's gravity. The term “horizontal” refers to a direction perpendicular to “vertical.”

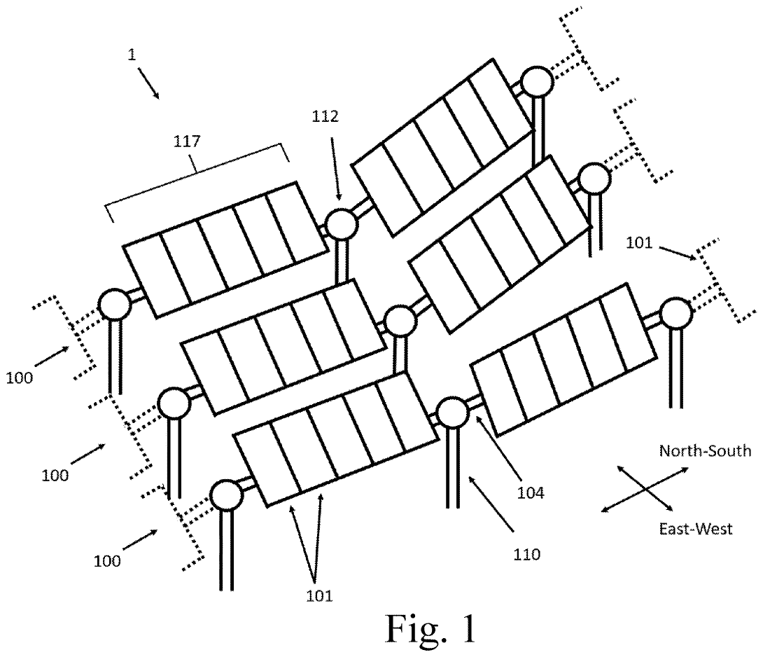

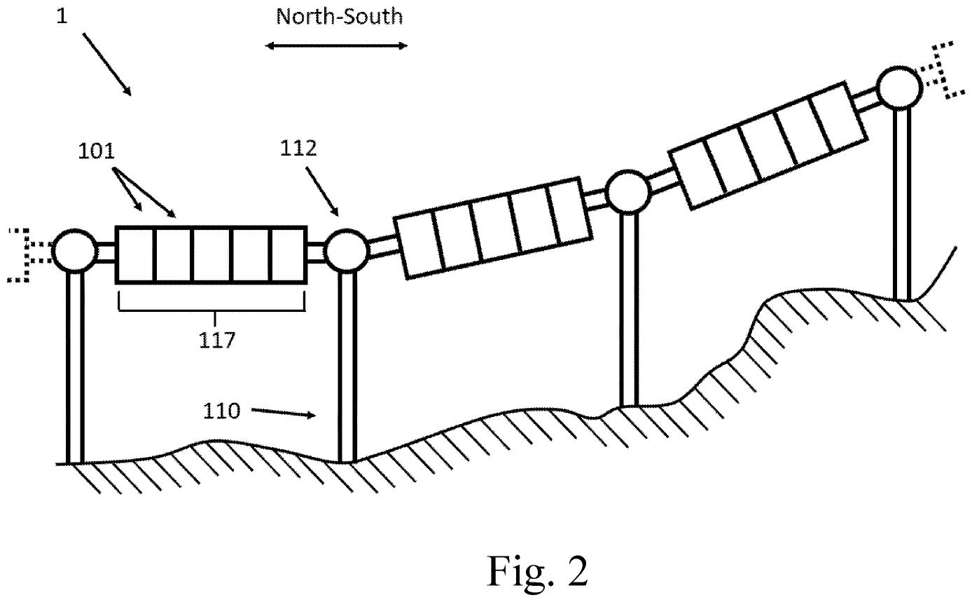

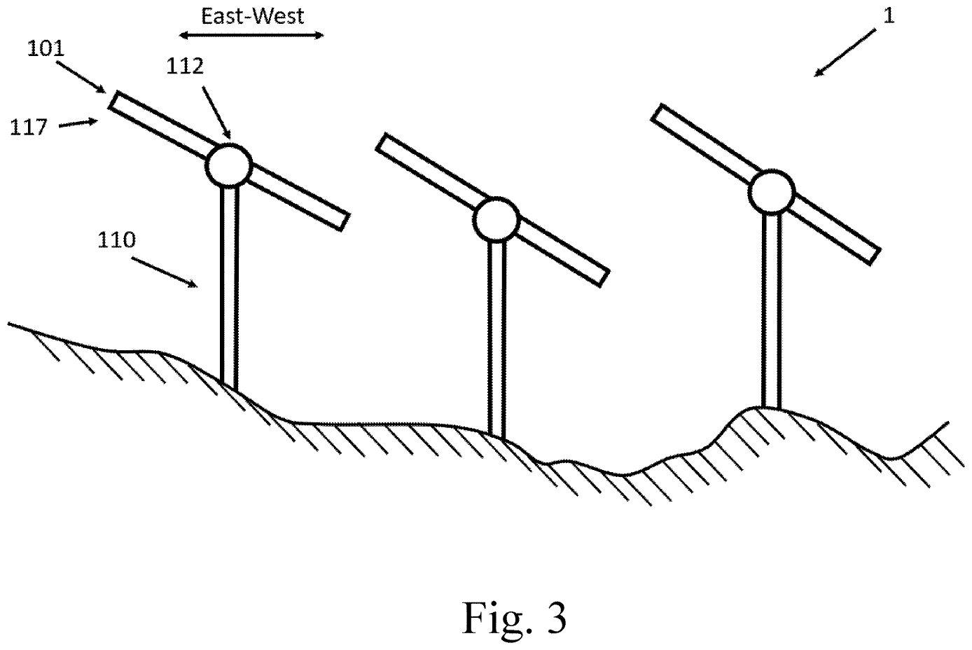

FIGS. 1-3 illustrate a solar array site including multiple trackers. FIG. 1 depicts three trackers in the solar site array directly adjacent to each other, each running along or approximately along the north-south direction with solar modules extending lengthwise in or approximately in the east-west direction. Alternatively, the trackers may run along or approximately along the east-west direction with solar modules extending lengthwise in or approximately in the north-south direction, or any other desired orientation. An angle change is depicted in all three trackers at the bearing assembly 112. The rightmost tracker on the page illustrates that a tracker or a bay 117 in a tracker may a different angle with relationship to the North-South axis than its neighbor(s). Bearing assemblies 112 disposed on a support post 110 could be any of the bearing assemblies described below, such as an articulating bearing assembly. A bay 117 includes a series of solar modules disposed directly adjacent to each other. The bay 117 may be bounded by bearing assemblies 112 and disposed on a single solar panel support 104 (e.g., a torque tube). A single bay 117 may have solar panel modules 101 that have parallel normal vectors and also lie on a same plane as each other, which holds true even as the torque tube rotates the solar modules (in this paper, “solar modules” is used interchangeably with “solar panels” unless otherwise stated). The bays 117 in a single tracker and/or across different trackers may have the same number of solar panel modules 101 or different number of solar panel modules 101 as each other, such as from 1 to 20 solar modules, such as from 3 to 15, such as from 5 to 10. The dashed lines at the “ends” of the trackers indicate that there may be more solar panel support 104 and solar panel modules 101 extending in one or either direction, such as more bays. FIG. 2 depicts a cross section of a solar array site looking along the east-west axis, depicting a single tracker with at least three bays 117 for ease of understanding. FIG. 3 depicts a cross section of a solar site array looking along the north-south axis. Three trackers of the solar site array are depicted side by side on the sloped landscape. The solar panel modules 101 in the bays 117 are tilted away from the horizontal. For ease of understanding, only one bay 117 in each of the three trackers is depicted, although in a physical site other bays further down the tracker may be visible from this perspective due to angle changes at the bearing assemblies 112.

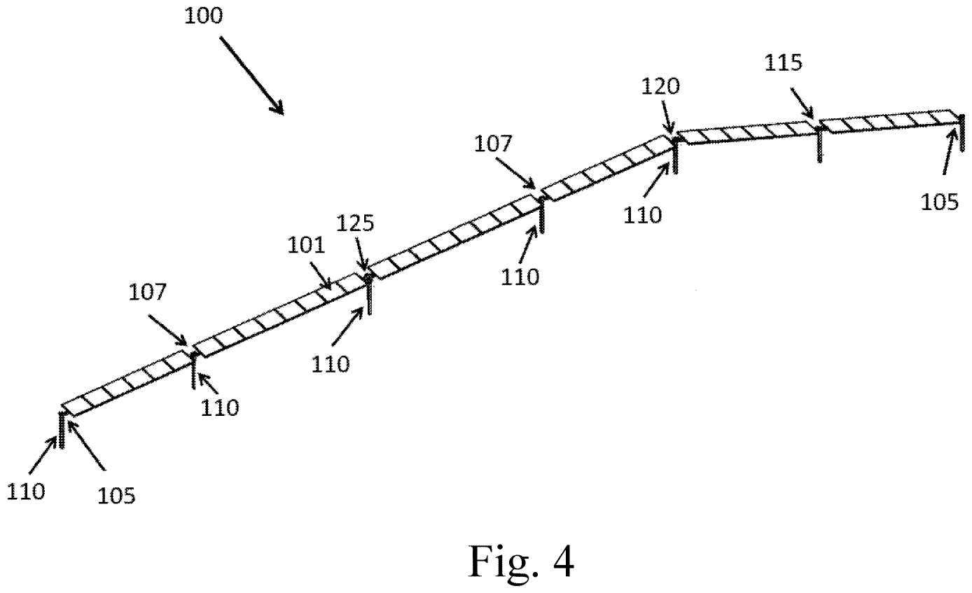

FIG. 4 shows an example of an individual all-terrain solar tracker (such as included in the solar array site described above) arranged on varying terrain with angle changes along its length to follow the natural terrain. This tracker employs examples of many of the components that may or may not be present in a tracker. These components include articulated bearings supporting significant changes in angular orientation between adjacent segments of the torque tube, flexure bearings supporting smaller changes in angular orientation between adjacent segments of the torque tube without requiring an articulated bearing, straight through bearings, mechanical stops limiting rotation of the tracker, and a row end bearing. The tracker in addition includes a slew drive configured to drive rotation of the torque tube around its long axes. Although the example of FIG. 4 and other figures shows a particular arrangement of certain components, other variations may employ any suitable combination and arrangement of the components described in this disclosure. Some elements illustrated in certain figures may be unlabeled in those figures and only be labelled in other figures, for convenience and clarity of illustration and to avoid repetition.

The variable terrain and single axis solar tracker 100 of FIG. 4 employs support posts 110, solar panel module supports 104 such as torque tubes extending between the support posts, and solar panel modules 101 supported by the torque tubes. Torque tubes may be tubes having a cross-section of four or more flat sides, such as a rectangle, square, pentagon, hexagon, and octagon, for example. Torque tubes may have cross sections that are round instead of having flat sides, such as circles or ovals. Multiple solar panel modules may be between each of the support posts, and they may all be of a same size as one another, or some of them may be different sizes from each other. The solar panel modules may each comprise a solar module frame which supports the solar cells in the panels. The number of solar panel modules between each of the support posts may be the same along the tracker, or it may vary depending on the terrain and the spacing of specific support posts. All the solar panel modules in between two of the support posts may be collectively referred to as a bay, and they may lie in the same plane as each other even as they are rotated by the tracker and slew drive.

This example variable terrain solar tracker is arranged on uneven terrain and includes two rotation axes: a first rotation axis arranged along a slope, and a second horizontal rotation axis along a flat portion of land above the slope. The angle between the first rotation axis and the second horizontal rotation axis may be, for example, ≥0 degrees, ≥5 degrees, ≥10 degrees, ≥15 degrees, ≥20 degrees, ≥25 degrees, ≥30 degrees, ≥35 degrees, ≥40 degrees, ≥45 degrees, ≥50 degrees, ≥55 degrees, ≥60 degrees, ≥65 degrees, ≥70 degrees, ≥75 degrees, ≥80 degrees, ≥85 degrees, or up to 90 degrees. These examples refer to the magnitude of the angle between the first rotation axis and the second horizontal axis. The angles may be positive or negative.

Various types of bearing assemblies 112 may be disposed on top of support posts, depending on the terrain and the position of the support post with relation to the rest of the trackers: straight-through bearing assemblies 107 for sloping planar surfaces, flat land bearing assembly 115 for flat land, row end bearing assembly 105 for an end of a the tracker, articulating joint bearing assembly 120 for changing terrain angles, and slew drive assembly 125 at an end of the tracker or an intermediate position along the tracker in order to drive rotation of the tracker.

For example, opposite ends of the tracker are rotationally supported by row end bearing assemblies 105 on support posts 110. The portion of the tracker arranged on the slope is supported by straight-through bearing assemblies 107, which include thrust bearings that isolate and transmit portions of the slope load to corresponding support posts 110. The portion of the tracker arranged on flat land, above the slope, is rotationally supported by a flat land bearing assembly 115 which may be a conventional pass-through bearing assembly lacking thrust bearings as described above. The slew drive assembly may drive rotation of the solar panel modules 101 about the first and second rotation axes to track the sun. The solar panel modules 101 may be supported on torque tubes that are parallel with and optionally displaced (e.g., displaced downward) from the rotation axis of the slew drives. The torque tubes may also be aligned with rather than displaced from the rotation axis of the slew drives. Articulating joint bearing assembly 120 links the two non-collinear rotation axes and transmits torque between them. Example configurations for bearing assemblies 105, 107 and 120 are described in more detail below.

Other variations of the variable terrain solar tracker 100 may include other combinations of bearing assemblies 105, 107, 115, and 120 arranged to accommodate one, two, or more linked rotational axes arranged along terrain exhibiting one or more sloped portions and optionally one or more horizontal (flat) portions. Two or more such trackers may be arranged, for example next to each other in rows, to efficiently fill a parcel of sloped and/or uneven terrain with electricity-generating single axis tracking solar panels.

As noted above articulating joint bearing assembly 120 accommodates a change in direction of the rotational axis along the tracker. As used herein, “articulating joint” refers to a joint that can receive torque on one axis of rotation and transmit the torque to a second axis of rotation that has a coincident point with the first axis of rotation. This joint can be inserted between two spinning rods that are transmitting torque to allow the second spinning rod to bend away from the first spinning rod without requiring the first or second spinning rod to flex along its length. One joint of this type, which may be used in articulating joint bearing assemblies as described herein, is called a Hooke Joint and is characterized by having a forked yoke that attaches to the first spinning rod, a forked yoke attached to the second spinning rod, and a four-pointed cross between them that allows torque to be transmitted from the yoke ears from the first shaft into the yoke ears of the second shaft.

The processes and methods described in this specification may be implemented by a hardware computer system. A computer system may include at least one of a processor, memory, non-volatile storage, and an interface. A typical computer system may include at least one or more of the following: a processor, memory, a general-purpose central processing unit (CPU), such as a microprocessor, and/or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software may be stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this description. Even when software is moved to the memory for execution, the processor may make use of hardware registers to store values associated with the software, and local cache that, ideally, serves to speed up execution. A software program may be assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

The computer systems can be compatible with or implemented as part of or through a cloud-based computing system. As used in this description, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this description can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine or through multiple engines. As used in this description, an engine includes at least two components: 1) a dedicated or shared processor and 2) hardware, firmware, and/or software modules that are executed by the processor. Depending upon implementation-specific or other considerations, an engine can be centralized or its functionality distributed. An engine can include special purpose hardware, firmware, or software embodied in a computer-readable medium for execution by the processor. The processor may transform data into new data using implemented data structures and methods, such as is described with reference to the FIGS. in this description.

The engines described herein, or the engines through which the systems and devices described herein can be implemented, can be cloud-based engines. A cloud-based engine may be an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

Datastores may include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described herein.

Datastores can include data structures. A data structure may be associated with a particular way of storing and organizing data in a computer so that it can be used efficiently within a given context. Data structures may be based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure may entail writing a set of procedures that create and manipulate instances of that structure. The datastores can optionally be cloud-based datastores. A cloud-based datastore may be a datastore that is compatible with cloud-based computing systems and engines.

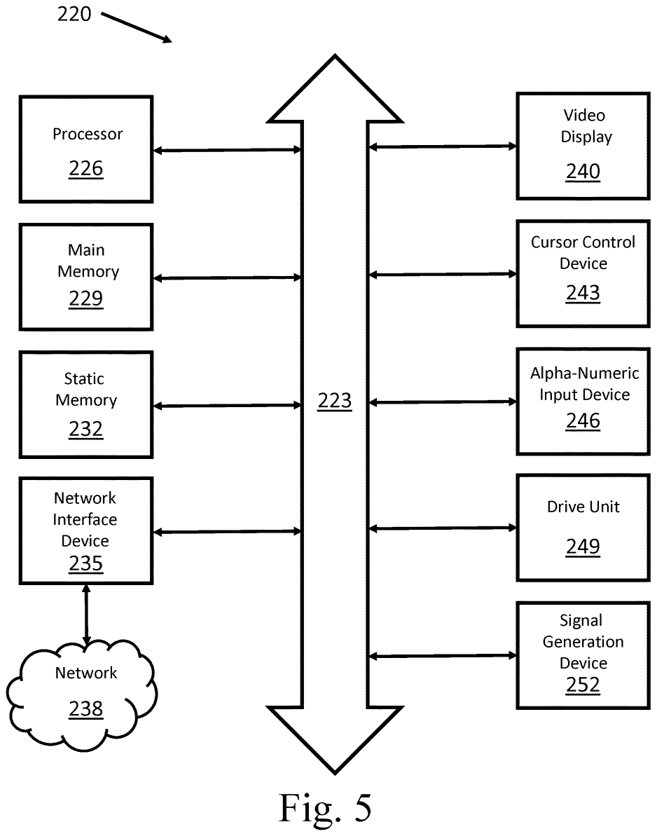

FIG. 5 is a block diagram of a machine in the example form of a computer system 220 within which instructions for causing the machine to perform any one or more of the methodologies discussed herein may be stored and/or executed. The machine may operate as a standalone device or may be connected (e.g., network) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 220 may include a processor 226 (e.g., a central processing unit (CPU), a graphics processing unit (GPU) or both), a main memory 229 and a static memory 232, which communicate with each other via a bus 223. The computer system 220 may further include a video display unit 240 (e.g., a liquid crystal display (LCD) or a cathode ray tube (CRT)). The computer system 220 also includes an alphanumeric input device 246 (e.g., a keyboard), a user interface (UI) navigation (or cursor control) device 243 (e.g., a mouse), a disk drive unit 249, a signal generation device 252 (e.g., a speaker) and a network interface device 235 connected to a network 238.

The disk drive unit 249 (e.g., a hard disk) may include a computer-readable medium on which is stored one or more sets of data structures and instructions (e.g., software and/or algorithms) embodying or utilized by any one or more of the methodologies or functions described herein. The instructions may also reside, completely or at least partially, within the main memory 229 and/or within the processor 226 during execution thereof by the computer system 220, the main memory 229 and the processor 226 also may constitute machine-readable media. The instructions may also reside, completely or at least partially, within the static memory 232.

The term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks. Machine-readable media may also include random access memory (RAM) (such as dynamic RAM (DRAM) and static RAM (SRAM)).

The instructions may further be transmitted or received over a communications network 238 using a transmission medium. The instructions may be transmitted using the network interface device 235 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software. The network interface device 235 may include one or more modems, network interface cards, wireless network interfaces or other interface devices, such as those used for coupling to Ethernet, token ring, or other types of networks.

Embodiments of the computer system may not require every element illustrated in FIG. 5 to be present, such that elements depicted in FIG. 5 may be optional. For example, an embodiment of a computer system used to implement embodiments of the invention may not include a signal generation device 252 or a cursor control device 243.

Some portions of the detailed description herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

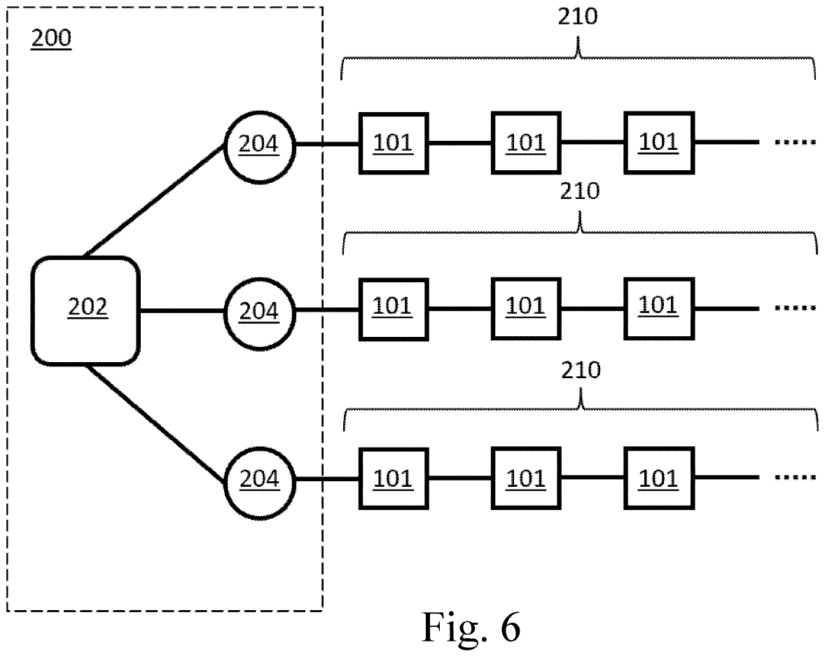

FIG. 6 shows an example of a solar panel array control system 200 coupled to a solar panel array. The solar panel array control system 200 may communicate with the solar panel array. The solar panel array control system 200 and/or elements of the solar panel array control system 200 (such as the central controller 202 and/or group control systems 204) may include, be included in, or consist of the computer system 220 or elements of the computer system 220 described above.

The solar panel array may include one or more solar panel groups 210 each including one or more solar panel modules 101. The groups 210 may include one or more solar panels connected in series, in parallel, or any combination thereof. The solar panel groups may include rows of solar panels, and may be trackers 100 as described above. Any description herein of rows of solar panels may apply to any other type of arrangement or grouping of solar panels.

Optionally, each group of solar panels may each have (e.g., be coupled to and in communication with) a group control system 204. Each group control system 204 may control operation their respective solar panel group 210. The group control systems 204 may be referred to as row controllers when controlling rows of solar panels. Any number of solar panel groups and/or group control systems may be provided. Each group may comprise any number of solar panels. Each group may have the same number of solar panels or differing numbers of solar panels. A central controller 202 may optionally be provided that may control the group control systems.

The solar panel array control system 200 may comprise the central controller 202 and, optionally, one or more group control systems 204. In some instances, one-way communication may be provided from the central controller to the one or more group control systems. The central controller may send instructions to the one or more group control systems, which may in turn control operation of the corresponding solar panel groups. In some instances, two-way communication may be provided between the central controller and the one or more group control systems. For instance, the group control systems may be group controllers that may send data to the central controller. The central controller may send instructions to the group controllers, for example in response to, or based on, the data received from the group controllers. The data from the one or more group controllers may optionally include data from one or more solar panels, or various types of sensors physically included as part of the solar panel group (e.g., on a torque tube, foundation, bearing assembly, or other part of the tracker), physically remote from the solar panel group, and/or otherwise physically or electrically coupled to the solar panel group.

The solar panel array control system may direct and affect operation of the solar panels, which may include positioning of the solar panels. The control system may affect an orientation of the solar panel. The control system may control amount of rotation, rate of rotation, and/or acceleration of rotation of one or more solar panels. The control system may affect a spatial disposition of the solar panel. The control system may control an amount of translation, speed of translation, and/or acceleration of translation of one or more solar panels. The control system may affect operation of one or more driving mechanisms for a solar panel array, for example by sending signals to the slew drive coupled to one or each of the solar panel groups, which may then control orientation of the solar panels. The solar panels may be positioned in response to one or more factors, as previously described herein. The solar panel array control system may affect other operations of the solar panels, such as turning the solar panels on or off, operational parameters of converting the solar energy to electrical energy, diagnostics, error detection, calibration, or any other type of operations of the solar panels.

In one example, a method of optimizing power generation throughout a field of trackers may be provided. Operational data for each grouping (e.g., each row) of solar panels may be provided. Any description herein of a row may apply to any grouping. The method may include collecting row-level operational data in aggregate, or piecemeal, to determine the operational characteristics of one or more rows of trackers. Power generation data of each row may be measured to determine if shading is occurring from one row to the next. The method may include analyzing total field power generation to determine if shading specific rows, while further optimizing or adjusting the tilt of other rows for generating power, will increase overall field power generation.

Row-level tests may be performed to determine the impact of shading of one or more rows on the one or more neighboring rows with regard to power generation of the neighboring rows. Row-level tests may be performed on one or more rows to determine if an optimum orientation assumption yields optimum or increased power generation. Tracking schedules may be updated to optimize or increase power generation throughout a tracker field or for each individual row. Row-level power generation may be monitored and compared with weather station reports to determine if sun-tracking operations or non-sun-tracking operations will yield greater power generation. Based on the comparison, an operation may be selected to yield the greater power generation.

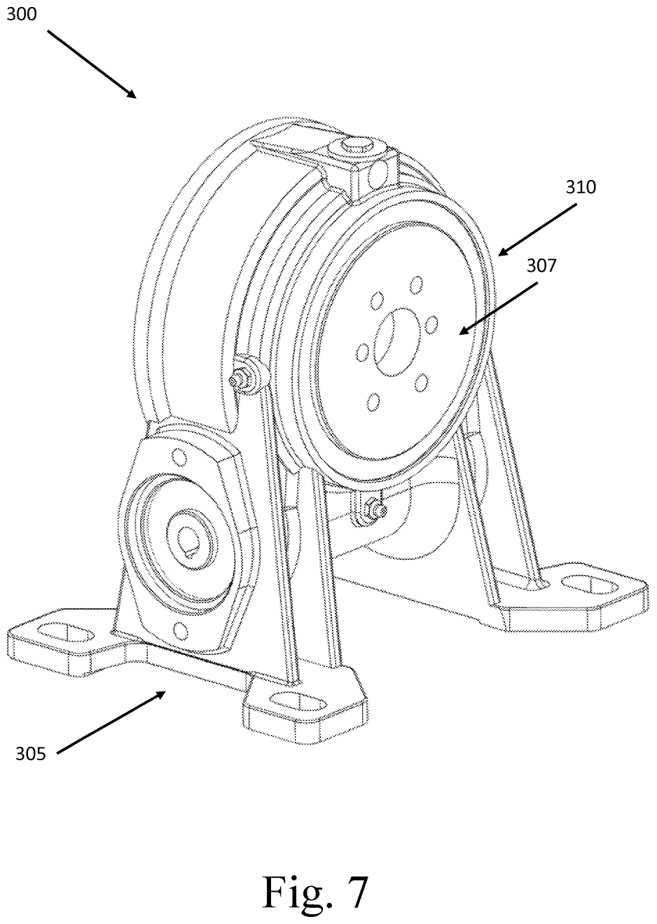

Orientation of the solar panels in a tracker may be mechanically achieved with a slew drive. FIG. 7 illustrates a slew drive 300 that is part of a slew drive assembly 125. The slew drive 300 may include a slew drive base 305 and a slew drive top 310. The slew drive top 305 and the slew drive base 305 may be integral with each other, or they may be formed as separate pieces and connected together (e.g., bolted).

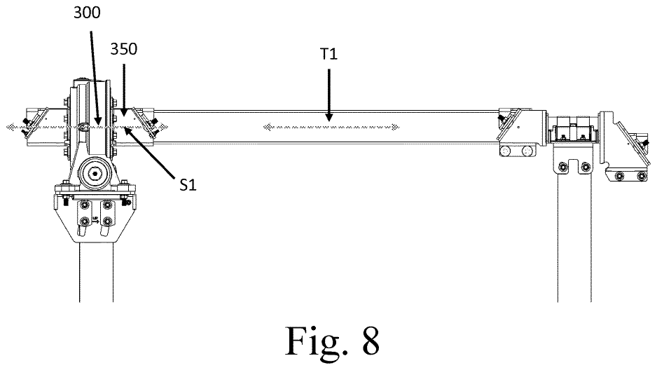

As shown in FIG. 8A, Cradles 350 may be attached to be in direct contact with to the slew drive 300, such as at a face 307 of the slew drive top 305. The cradles 350 may each be used to support and secure one of the solar panel supports 104 (e.g., torque tubes) such that they are in direct physical contact with the solar panel supports 104. In operation, the slew drive 300 may drive rotation of the solar module supports (e.g., torque tubes). The slew drive 230 may drive rotation of the torque tubes via the cradles 350. The slew drive base 305 is mounted directly in contact with and/or coupled to a support post 110.

The slew drive axis S1 may be the axis around which the slew drive 300 rotates the solar panel supports. The slew drive axis S1 of a slew drive 300 may be aligned with the solar panel support axis T1 of the of the solar panel support 104 immediately adjacent to the slew drive 300. This type of slew drive may be called a concentric slew drive, since it may have one or more cradles 100 whose attachment surface centers align with the center of the concentric slew drive and/or cradles 100 carrying torque tubes whose torque tube axis aligns with the center of the concentric slew drive. The face 307 of the slew drive 300 may have a circular cross section when viewed staring down the slew drive axis S1; here, the slew drive center is the center of the circle that makes up the face 307. This center may be the slew drive axis S1 around which the slew drive 300 rotates the solar panel supports, solar modules and/or bearing assemblies to which it is coupled to. In FIG. 8, the tracker has a first torque tube 104 having torque tube axis T1. Another torque tube may extend from the opposing side of the first torque tube and have an axis T2. This axis T2 may be offset from axis T1. Consequently, axis T2 may be offset from slew drive axis S1 and the center of slew drive 190. For example, it may be at a lower elevation, or it may be at a greater elevation.

Alternatively, a slew drive axis S1 of a slew drive 300 may not be aligned with the solar panel support axis T1 of the solar panel support 104 immediately adjacent to the slew drive 300. For example, the slew drive axis S1 may be above the solar panel support axis T1. On the other hand, any solar panel modules 101 disposed on that solar panel support 104 and/or subsequent solar panel support down the tracker may have their center of masses aligned with the slew drive axis S1, so that the slew drive 300 may rotate these solar modules around their center of masses.

The slew drive 300 may be electrically and/or directly physically connected to a pony module, i.e., a solar panel rotating over the slew drive 300 which may be smaller than the other solar modules in the tracker, and/or powers the slew drive and a controller on the tracker (e.g., a row controller). The slew drive 300 may be electrically and/or directly physically connected to controller which controls the slew drive. The pony module may power and/or charge the controller and/or the slew drive.

The slew drive 300 may have a worm gear to drive rotational motion and a stop feature to stop rotation of the worm gear or components of the worm gear from further rotating the tracker past a certain point. For example, the worm gear may be otherwise capable of rotating the solar modules in a tracker by 360 degrees if the stop feature were not included, and the inclusion of the stop feature in the slew drive 300 may prevent rotation of the solar modules in the tracker past a certain degree. Conventionally, a slew drive may prevent rotation of the solar modules past 55 degrees or 60 degrees. A stop feature may be present to prevent damage to and/or stop undesirable behavior of the tracker. If the stop feature were not present, high winds may cause undesirable rotation of the solar modules, which might damage the tracker and/or decrease its efficiency of energy generation.

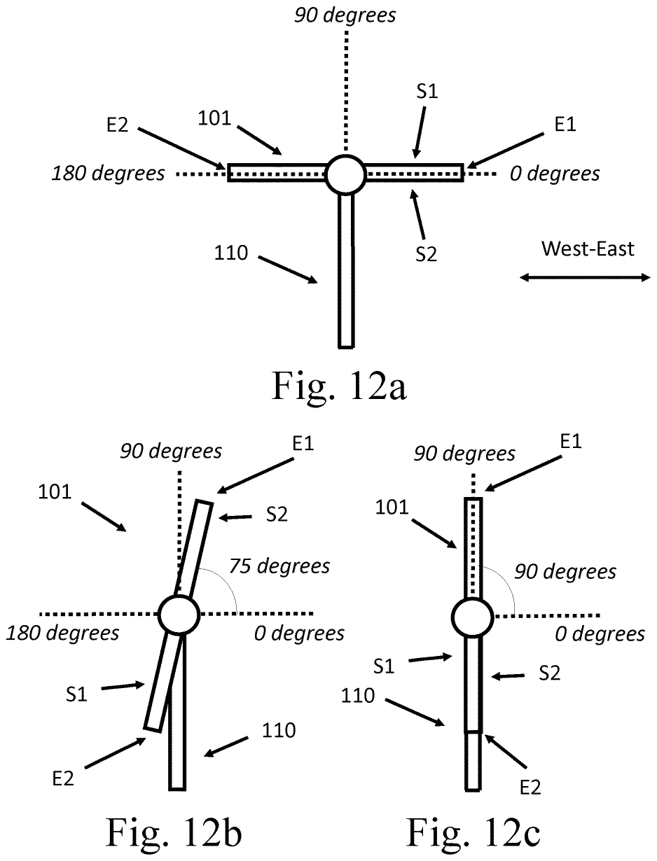

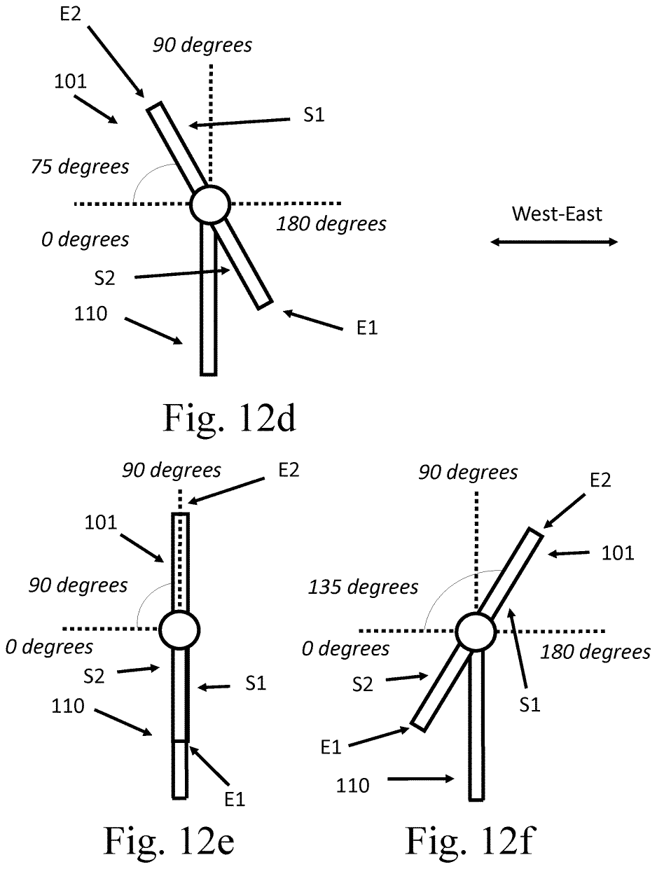

In embodiments of the invention, the stop feature allows rotation of the solar modules in the tracker to and prevents rotation past, for example, 75 degrees, 90 degrees, 100 degrees, 110 degrees, or 180 degrees. That is, the slew drive 300 may allow rotation of the solar modules on the solar module supports through the entire ranges of 0-75 degrees, 0-80 degrees, 0-90 degrees, 0-100 degrees, 0-110 degrees, or 0-180 degrees, and may prevent rotation of the solar modules outside of these examples ranges. The degree of the solar modules may be determined with respect to the horizontal. For example, when the solar modules are “flat,” i.e., when the solar modules have their planes/surfaces parallel to (flat) ground below them, they may be considered to be at 0 degrees. When the solar modules have their planes/surfaces oriented perpendicular to (flat) ground below them, they may be considered to be oriented at 90 degrees. This is shown in FIGS. 12a-12c. FIG. 12a shows the solar module oriented at 0 degrees, FIG. 12b shows the solar module oriented at 75 degrees, and FIG. 12c shows the solar module oriented at 90 degrees. The dashed lines are imaginary lines indicating where the solar module must line up to in order to be oriented at 0, 90 degrees, and 180 degrees, following the 360 degrees of a circle. The orientation of the 0 degree line may be chosen depending on whether edge E1 or edge E2 is chosen. That is, the 0 degree line may be for example pointed towards the East (FIGS. 12a-12c) or the West (FIGS. 12d-12f) depending on whether edge E1 or edge E2 is being measured as a reference point. In FIG. 12a, the solar module may be considered to be oriented at 0 degrees with surface S1 facing up (e.g., towards the sky) and surface S2 facing down (e.g., towards the ground) because edge E1 is aligned with the 0 degrees line. In FIGS. 12b and 12c, the eastern 0 degrees line is maintained, and the angle of 75 degrees and 90 degrees respectively are measured with reference to edge E1. If the solar module were oriented with surface S1 facing down and surface S2 facing up, then it may be considered to be oriented at 180 degrees because edge E1 would be aligned with the 180 degrees line.

On the other hand, in FIGS. 12d-12f, the 0 degrees line is pointed towards the West because edge E2 is being considered, and it points towards the west when the solar module is flat with side S1 facing up (e.g., FIG. 12a). The angles of 75 degrees, 90 degrees, and 135 degrees are the measured with regards to edge E2 with the western 0 degree lines. As one example of a shorthand way of referring to the angles, FIGS. 12a-12c have the solar module oriented at 0 degrees, 75 degrees, and 90 degrees at the eastern side, and FIGS. 12d-12f have the solar module oriented at 75 degrees, 90 degrees, and 135 degrees at the western side.

The stop feature may be one or more internal stops inside the casing of the slew drive 300 that physically stops the worm gear from rotating the solar module of the trackers past the predetermined range. For example, the stop feature may not be visible from the outside of the slew drive 300.

Orienting the solar modules in the tracker anywhere in the range from, say, past 60 degrees up to 75 degrees, or past 60 degrees up to 90 degrees, may enable mitigation or increase mitigation of damage from hail stones. For example, the hail stones might be traveling, on average, perpendicular to the ground. In this case, the steeper the angle of the solar modules, the greater the angle of incidence of the hail stone will be with regards to the surface of the solar module (i.e., the larger the angle between the hail stone trajectory and the line perpendicular to the planar surface of the solar module). Advantageously, the hail stones will be more likely to strike the solar module with a glancing blow, and damage to the solar modules is less likely as a result of this steeper angle.

Orienting the solar modules in the tracker past 60 degrees may increase wind loads on the solar modules. As a result, a tracker with a slew drive 300 that has a 75 degree stop may require more materials and cost to product compared to a slew drive that has a 60 degree stop, simply because the solar modules have the capability to catch more winds at a steeper angle. For example, the support posts 110 in the former tracker may be made thicker and/or taller than the support posts 110 in the latter. The increase in initial costs may be outweighed by the prevention of costly damage to the solar modules in the long run.

In addition to the stop feature on the slew drive 300, mechanical stop assemblies may also be provided along the tracker to further ensure that rotation of the solar modules does not go past a certain angle. The mechanical stop assemblies may include or be in place of the bearing assemblies 112 in the tracker. In other words, the mechanical stop assemblies may be disposed on and over support posts 110 placed between solar panel supports 104, such as at the locations of any of straight through bearing assembly 107, slew drive assembly 125, articulating joint bearing assembly 120, and flat land bearing assembly 115 shown in FIG. 4.

The internal stops and/or the mechanical stop assemblies may stop the rotation of the solar panel asymmetrically with respect to the eastern side and the western side. That is, the solar tracker may have a first maximum angle at the eastern side that is different from a maximum angle at the western side. In one example, a solar tracker may have a maximum angle of 90 degrees rotation at the eastern side (FIG. 12c) while having a different maximum angle of 135 degrees rotation at the western side (FIG. 12f). In this example, the solar tracker has 0-90 degrees of rotation at the eastern side and 0-135 degrees of rotation at the western side. Of course, this is not required, and the solar tracker may have a first maximum angle at the eastern side that is the same as a maximum angle at the western side.

Furthermore, the solar tracker may determine whether there is wind or hail at the tracker site, and orient the modules at a different range of degrees depending on whether wind or hail is determined. For example, if it is determined there is wind, the modules may be oriented from 45-75 degrees. However, if its determined there is hail, the modules may be oriented from 55-90 degrees. Alternatively, the wind and hail ranges may be mutually exclusive from each other, such as wind stow being at from 45-60 degrees and hail stow being past 60 degrees to 90 degrees. These degree ranges may of course be changed based on desired performance and foundation strength at the actual site; the key point is that they may be different from each other depending on whether there is wind or hail.

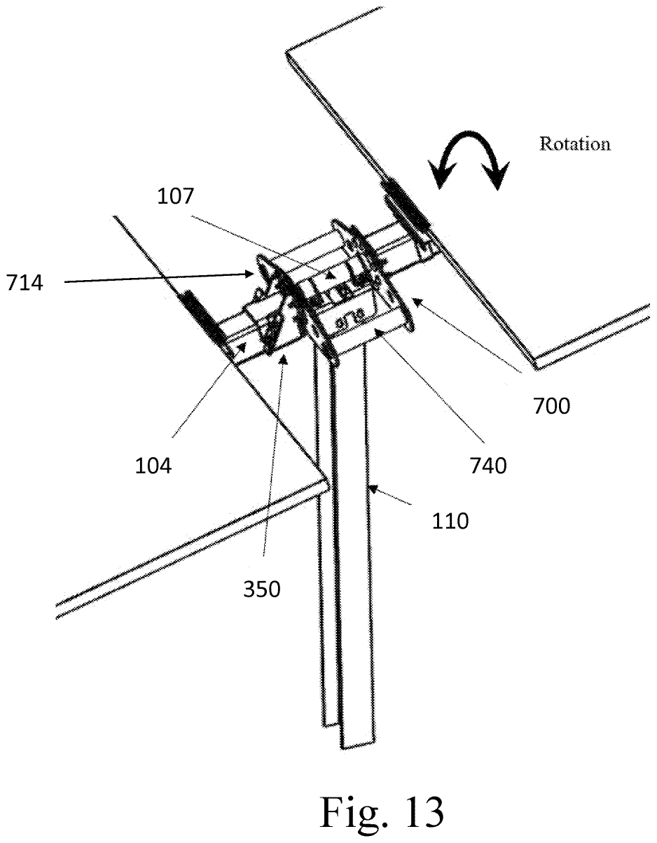

FIG. 13 shows an example of a mechanical stop assembly 700 for a single-axis tracker that incorporates two cradles 350, one integrated straight through bearing assembly 107, two impact bars 740, one foundation 110, and solar panel supports 104. Solar panel supports may be inserted into the cradles on either side of the mechanical stop assembly. Solar modules may be mounted on the one or more torque tubes and rotated. A mechanical stop assembly may be mounted onto an integrated straight bearing assembly, or other type of bearing assembly (e.g., compact straight bearing assembly, a flexure bearing assembly, articulated bearing assembly, etc.), or provided as a separate and standalone assembly. At some angle, the impact bracket may contact an impact surface structure resulting in a physical blockage to further rotation of the torque tube. The impact surface structure may be the post of the foundation itself or a horizontal bar on the foundation that contacts the impact bracket assembly. The impact bracket assembly might have two parallel plates extending outward without an impact bracket between them so that the plates contact a bar on the foundation, or the plates may include the impact bracket extending between them to contact the foundation to result in the physical blockage. This physical blockage allows rotational loads applied to the torque tube to be resisted at this foundation when tilted to an angle that contact is made. Zero, one, or more mechanical stop assemblies may be incorporated in a tracker row to provide zero, one, or more physical blockages to rotation. If one mechanical stop assembly contacts a foundation before one or more other mechanical stop assemblies contact the foundation, then the one or more other mechanical stop assemblies may still contact the foundation in wind conditions that create sufficient flexing in the torque tube and bearing assemblies in the rest of the tracker system to allow the non-contacting mechanical stops to come into contact with their respective foundation. The mechanical stop assembly illustrated in FIG. 2 has two sides to stop both of a clockwise rotation of the bearing assembly 101 at a first maximum angle of rotation and stop a counterclockwise rotation of the bearing assembly 101 at a second maximum angle of rotation. For example, the one or more mechanical stop assemblies 700 may physically stop rotation of the solar panels on the tracker past a certain degree by contacting the impact surface structure, such as 75 degrees, 90 degrees, 100 degrees, 110 degrees, or 180 degrees. That is, the mechanical stop assemblies 400 may allow rotation of the solar modules on the solar module supports through the entire ranges of 0-75 degrees, 0-80 degrees, 0-90 degrees, 0-100 degrees, 0-110 degrees and may prevent rotation of the solar modules outside of these example ranges. In order to physically stop rotation past the allowed ranges, the plates 714 bearing the impact bars 740 may be angled at (270-maximum angle) degrees with respect to the horizontal, when the tracker is oriented to have the solar modules in a horizontal position. That is, if the maximum angle is 75 degrees, the plates 714 bearing the impact bar 740 on at least one side of the mechanical stop assembly 700 may be angled at 195 degrees (using FIGS. 12a-12c as reference for where 0 degrees begins).

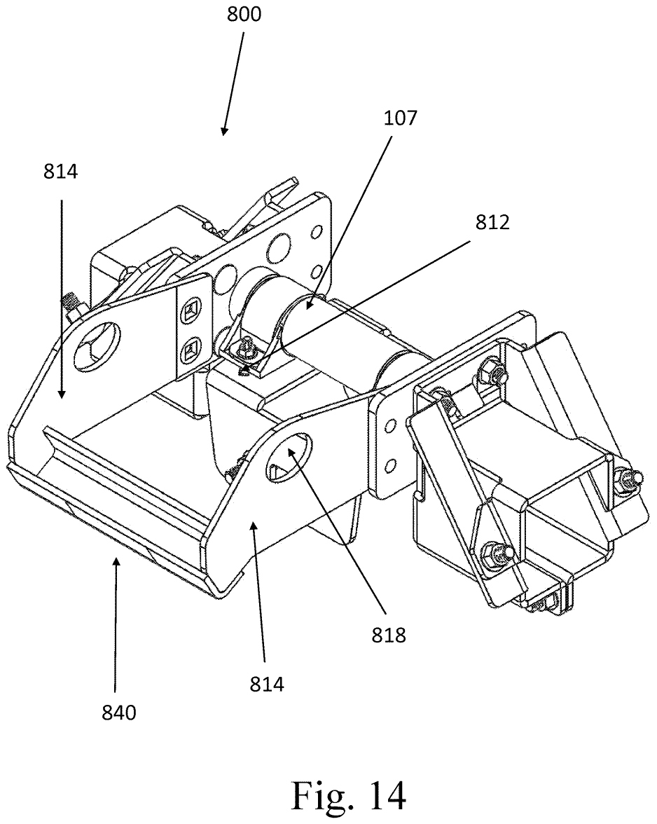

FIG. 14 shows a mechanical stop assembly 800 with an impact bar 840 on only one side of the bearing assembly 107 (rather than the two illustrated in FIG. 13), to stop only one of clockwise or counterclockwise rotation of the bearing assembly 101 at a first maximum angle of rotation. Also illustrated in this figure are two plates 814. The two plates 814 are parallel to each other and have the impact bar 840 between them and perpendicular to their direction of extension. The two plates 814 are attached at an attachment region to the bearing assembly. They can be removed from the bearing assembly and/or mounted at the opposing side of the bearing assembly. The two plates may have a hole 518 that either accommodates cables or accommodates hooks that supports cables in the tracker. The mechanical stop assembly 800 may comprise a bearing support having bearing support slots 812 that allow pivoting and/or rotation of the bearing about an axis perpendicular to the bearing, e.g. an axis parallel to the long axis of the foundation. For example, the bearing support slots 812 may allow East-West rotation.

The one or more mechanical stop assemblies 800 may physically stop rotation of the solar panels on the tracker past a certain degree by contacting an impact surface structure, such as 75 degrees, 90 degrees, 100 degrees, 110 degrees, or 180 degrees. That is, the mechanical stop assemblies 500 may allow rotation of the solar modules on the solar module supports through the entire ranges of 0-75 degrees, 0-80 degrees, 0-90 degrees, 0-100 degrees, 0-110 degrees and may prevent rotation of the solar modules outside of these example ranges.

Embodiments of the invention include numerous ways of triggering the orientation of the solar modules at this mechanically increased solar module angle to prevent hail damage.

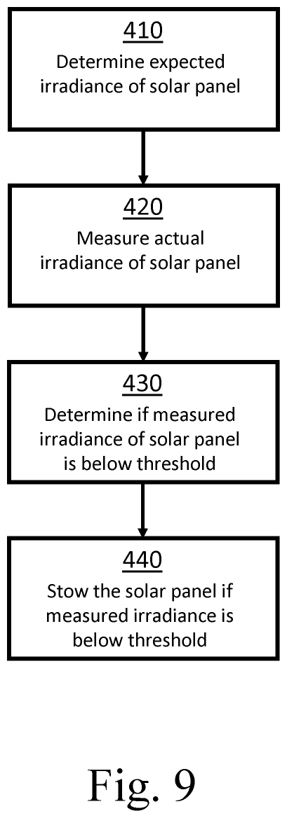

Hail storms that result in hailstones significant enough to damage solar panels may be severe convective storms with thick, dark clouds. In embodiments of the invention, the hail stow of the solar panels is triggered, causing the solar panels in a tracker to be oriented at a specific degree or within a specific range of degrees steep enough to mitigate damage from hail stones. For example, hail stow may comprise orienting all or some of the solar modules in the tracker at or near a maximum angle of orientation as allowed by the slew drive(s) and mechanical stop assemblies in the tracker. Hail stow may be triggered by determining whether irradiance on one or more solar panels is below expected irradiance, i.e. at some predetermined percentage. This process is shown in FIG. 9.

At 410, determine the expected irradiance of the at least one solar panel. The at least one solar panel may be a single solar panel, or it may be an arbitrary group of solar panels, such as a row of solar panels, all of the solar panels in a solar site, or a fraction of the solar panels in a solar site. Determining the expected irradiance may include determining a current or future time of day where the irradiance of the at least one solar panel is to be measured, determining a position of the sun at the time of day, determining a current or future angle of the at least one solar panel at the time of day, and/or calculating the irradiance based on the above information. Alternatively, the expected irradiance may be determined by looking up a chart including the relevant time of day and expected irradiance.

At 420, measure irradiance of the at least one solar panel. The irradiance may be measured by a one or more light sensors, current sensors, voltage sensors, and/or a power sensors electrically and/or physically connected to the at least one solar panel and/or a tracker within which the at least one solar panel is included or disposed in. The irradiance may be measured directly, or inferred from the current, voltage, or power generated by the at least one solar panel. For example, if all the solar panels in the site are to be measured, each row of a site may include sensors that measure the irradiance of that row, the irradiance may be reported to the row controllers that send them to a central controller, and the irradiance of the site may be determined on this row data.

At 430, determine if the actual/measured irradiance of the at least one solar panel is below a threshold. The threshold is a percentage of the expected irradiance. For example, the threshold may be below 20%, below 15%, below 10%, or below 5% of the expected irradiance. If the actual irradiance is below the threshold, then that may be a determination there is or will likely be hail at or near the tracker. The determination may be that there is a hail event currently at or over the tracker or that there will a hail event soon, for example such as within 5 minutes from the time of measured irradiance, such as within 10 minutes, such as within 30 minutes, and so on. The hail event may be defined by when hail falls over the tracker site.

At 440, if the measured irradiance is below the threshold as mentioned above, stow the at least one solar panel, and/or stow a group of solar panels including the at least one solar panel if it is the measured irradiance is below the expected irradiance. For example, there may be more solar panel(s) stowed than the number of the solar panel(s) measured. For example, if only some of the solar panels in the site had their irradiance measured (e.g., a single row of solar panels), then the other solar panels in the site may still be stowed along with the measured solar panels. That is, all of the solar panels that had their irradiance measured may be stowed, and some or all of the other solar panels in the site that did not have their irradiance measured may also be stowed. Alternatively, the measured solar panels and the stowed solar panels may be the exact same solar panels.

The stowed solar panels may be stowed at a predetermined stow degree which is uniform for all stowed panels. For example, the stowed solar panels may all be stowed at a predetermine degree from 60-65 degrees, from 60-70 degrees, from 60-75 degrees, from 60-90 degrees, from 75-90 degrees, etc. The steeper the stow, the more likely damage from hailstones may be mitigated, because the angle of incidence of the hail on the solar panel is increased.

Alternatively, the stowed solar panels may be stowed at predetermined stow degrees different from each other, depending on the placement of the particular solar panel in question within the site. For example, solar panels at the northern half of site may all be stowed at a degree different from the solar panels at the southern half of a site.

In this method, a hail stow may be triggered even if there is no actual hail event at or around the time of stowing, as clouds may decrease irradiance without hail. Because conventional methods of detecting hail may be unreliable, they may result in underpredicting hail events, resulting in damage from solar panels when they are not stowed. This method advantageously makes sure not to underpredict hail events, so that costly damage to solar panels is prevented by triggering stow.

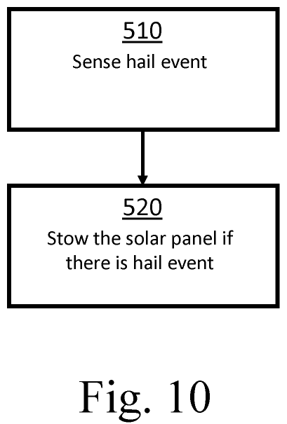

According to embodiments of the invention as depicted in FIG. 10, a hail stow may be triggered based upon on-site sensors determining there is a hail event or a high possibility of a hail event on or near the tracker site. The solar module site may include one or more sensors capable of detecting hail. For example, the solar module site may include one or more weather stations installed at the physical location of the solar module site. The weather station may include the one or more sensor capable of detecting hail, along with other sensors that may detect other weather events, such as rain or wind. The weather station may be on a network that is in coupled to and in communication with the solar panel array control system 200, e.g., the weather station may be coupled and in communication with either or both of the central controller 202 and/or group control systems 204. A site may include more than one weather station at locations designed to measure the weather at strategically important locations. For example, the weather stations may be designed to measure wind where they blow the strongest before reaching the solar panels, such as at the edges or four corners of a tracker site.

At 510, sense whether there is a current or imminent hail event using the hail sensor located in the one or more weather stations.

At 520, stow one or more solar panels if it a current or imminent hail event was sensed. The stow may be similar or the same as to that described above in relation to 440 in FIG. 9.

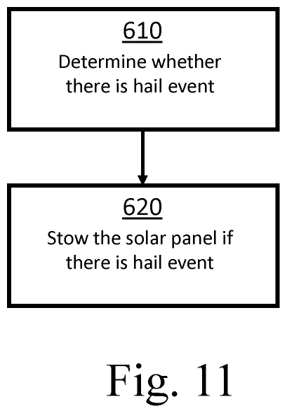

According to embodiments of the invention as depicted in FIG. 11, a hail stow may be triggered based on an off-site alert that there is a hail event or a high possibility of a hail event on or near the tracker site.

At 610, a processor and/or controller coupled to and in communication with the solar module site may receive an alert of a current or imminent hail event at or near the solar module site. For example, one or more elements of the solar panel array control system 200 may receive the alert. The alert may be received over a network that the solar panel array control system 200 is coupled to and in communication with, such as the internet. The alert may be received from a government and/or meteorology service.

At 620, stow one or more solar panels if it was determined there is a current or imminent hail event. The stow may be similar or the same as to that described above in relation to 440 in FIG. 9.

The disclosures provided in this specification are intended to illustrate but not necessarily to limit the described implementation. As used herein, the term “implementation” means an implementation that serves to illustrate by way of embodiments but not limitation. The techniques described in the preceding text and figures can be mixed and matched as circumstances demand to produce alternative implementations. It will be apparent to those of ordinary skill in the art that numerous variations, changes, and substitutions of the embodiments described above can be made without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. All such alternatives will be apparent to one skilled in the art in light of this disclosure and are intended to fall within the scope of the appended claims.

What is claimed is:

1. A method comprising:
determining expected irradiance of at least one solar panel comprised in a plurality of solar panels, the plurality of solar panels disposed in a solar tracker and being oriented at a first angle with respect to a horizontal direction;
determine actual irradiance of the at least one solar panel;
determine a ratio of the actual irradiance and the expected irradiance; and
based on the ratio, rotating the plurality of solar panels to a second angle with respect to the horizontal direction.

2. The method of claim 1, wherein the second angle is in a range greater than 60 degrees and up to 75 degrees.

3. The method of claim 1, wherein the second angle is in a range greater than 55 degrees and up to 85 degrees.

4. The method of claim 1, wherein the second angle is greater than the first angle.

5. The method of claim 1, further comprising determining, based on the ratio, whether there is a hail event at an installation site of the solar tracker.

6. The method of claim 5, wherein determining whether there is a hail event comprises comparing the ratio with a threshold ratio, and determining there is a hail event when the ratio is at or below the threshold ratio.

7. The method of claim 1, wherein the threshold ratio is from 0.05 to 0.2.

8. The method of claim 1, wherein the solar tracker is configured to prevent rotation of the plurality of solar panels past 90 degrees.

9. The method of claim 8, wherein the solar tracker comprises a slew drive configured to prevent rotation of the plurality of solar panels past 90 degrees.

10. The method of claim 8, wherein the solar tracker comprises a plurality of mechanical stop assemblies configured to stop rotation of the plurality of solar panels past 90 degrees.

11. The method of claim 1, wherein the expected irradiance is determined based on a selected time of day, and determining actual irradiance is done at the selected time of day.

12. The method of claim 1, wherein determining actual irradiance includes measuring current, voltage, and/or power.

13. The method of claim 1, wherein determining actual irradiance includes measuring with a light sensor disposed on the solar tracker.

14. The method of claim 1, wherein the at least one solar panel consists of the plurality of solar panels.

15. The method of claim 1, further comprising determining there is a hail event at an installation site of the tracker; and
wherein the second angle is from 0-90 degrees towards a first direction.

16. The method of claim 1, further comprising, before or after determining there is a hail event, determining there is a wind event at an installation site of the tracker; and
in response to determining there is a wind event and before or after rotating the plurality of solar panels to the second angle, rotating the plurality of solar panels to the first angle from either an initial angle or the second angle;
wherein the first angle is from 0-135 degrees towards a second direction opposite from the first direction.

17. A solar tracker, comprising:
a plurality of solar modules;
at least one solar module support upon which the plurality of solar modules are disposed;
a slew drive coupled to the at least one solar module support and configured to rotate the plurality of solar modules, the slew drive comprising a housing and an internal stop within the housing configured to stop rotation of the plurality of solar modules past a maximum angle, the maximum angle being from 65-90 degrees.

18. The solar tracker of claim 17, further comprising:
at least one mechanical stop assembly coupled to the at least one solar module support, the at least one mechanical stop assembly comprising a mechanical stop configured to stop rotation of the plurality of solar modules past the maximum angle; and
a foundation upon which the at least one mechanical stop assembly is disposed.

19. The solar tracker of claim 18, wherein the at least one mechanical stop assembly comprises a bearing and a second mechanical stop on an opposite side of the bearing from the mechanical stop.

20. The solar tracker of claim 17, wherein the maximum angle is a maximum angle at a first side of the solar tracker, and the solar tracker is configured to stop rotation of the plurality of solar modules past a maximum angle at a second side of the solar tracker opposite the first side, the maximum angle at the second side different from the maximum angle of at the first side.
